(19) United States
(12) Patent Application Publication
(10) Pub. No.: US 2025/0229211 A1
(43) Pub. Date: Jul. 17, 2025

(54) ATMOSPHERIC WATER GENERATION SYSTEM AND METHOD

(71) Applicant: Freshape SA, Renens (CH)

(72) Inventors: Mathieu Rubi, Ecublens (CH); Sebastián Alagón Carrillo, Ecublens (CH); Chin Lee Ong, Ecublens (CH)

(21) Appl. No.: 18/698,264

(22) PCT Filed: Oct. 8, 2021
(86) PCT No.: PCT/IB2021/059253

§ 371 Date: Apr. 3, 2024

(51) Int. Cl. B01D 53/04; B01D 53/26; E03B 3/28; H02S 40/44

(52) U.S. Cl. CPC B01D 53/0438; B01D 53/261; B01D 53/265; E03B 3/28; H02S 40/44; B01D 2253/106; B01D 2253/108; B01D 2257/80; B01D 2259/40098

(57) ABSTRACT

An atmospheric water generation system and method. At least one atmospheric water generation unit is provided which includes at least two successive processing stages. Each processing stage includes an adsorbent structure including an adsorbent material, which adsorbent structure is coupled to an adjacent vapor chamber to allow vapor transfer thereto. During an adsorption phase, moist ambient air is circulated through the adsorbent structures to cause adsorption of water therein. During a desorption phase, thermal energy is provided to the adsorbent structures to cause water adsorbed therein the be desorbed into water vapor. This water vapor transits to the adjacent vapor chamber where the water vapor condenses into a condensate.

### TECHNICAL FIELD

The present invention generally relates to an atmospheric water generation system and method.

### BACKGROUND OF THE INVENTION

Atmospheric water generation (also referred to by the acronym “AWG”)—or atmospheric water harvesting (“AWH”)—is known as such in the art and has gained significant interest as a potentially viable method for sustainable potable water production. Indeed, fresh water scarcity is increasingly affecting human population and more and more people are suffering from restrictions to potable water access, which problem is growing day by day. By 2025, it is estimated that approximately 1.8 billion people will be living in absolute water scarcity regions, while two thirds of the world's population will be living under water stressed conditions. By 2030, half of the world's population could be living under high water stress, i.e. without access to clean, fresh and safe drinking water.

Different solutions have been proposed in the art to address this problem, mainly (i) desalination and (ii) atmospheric water generation/harvesting (AWG/AWH). Desalination is a suitable solution allowing for high-capacity production. This solution is however only viable in coastal areas or in areas allowing in-land desalination with saline groundwater. AWG is a highly sustainable water production solution which in essence relies on capturing moisture from the air/atmosphere. Even in the driest of places, air humidity level is never zero, and a certain amount of water is always present in the air.

AWG technologies can in essence be segregated into three main categories, namely (i) solar stills, (ii) refrigeration systems/processes, and (iii) adsorption systems/processes, there being however further solutions.

Solar stills are relatively easy to setup as they only require a water container, a transparent collector and sunshine. This approach allows production of distilled water from undrinkable water sources from streams or lake water, saline water, or even brackish or contaminated water. The main disadvantage of this approach however resides in the fact that it requires an existing water source to be distilled for potable water production.

Refrigeration systems/processes requires a suitable system to deploy a refrigeration cycle, typically vapor compression using a compressor, condenser and evaporator for atmospheric water harvesting. Advantages include high mobility and up-scalable production capability. The main disadvantage however resides in the high energy consumption requirements, especially when relative humidity (RH) is low, in particular below 40%.

Adsorption systems/processes are typically based on thermal desiccation, a process using adsorbent materials (e.g. porous solids) to adsorb moisture from the atmosphere, desorb the adsorbed moisture, and then condense to produce a condensate. The main advantage of this approach resides in the fact that the desorption process only consumes low-grade heat as the relevant driving force and is deployable even for low humidity conditions. A small amount of electricity may be required for forced circulation of moist ambient air through the adsorbent material during the adsorption process. The main disadvantage resides in the fact that production is greatly dependent on the adsorbent characteristics of the adsorbent material being used.

The most widely deployed AWG solutions are typically based on (i) vapor compression (refrigeration and compressor based) or (ii) thermal desiccation with adsorbents. As pointed out previously, refrigeration-based AWG consumes electricity, while desiccant-based AWG essentially requires low-grade thermal energy as the driving force. For refrigeration-based AWG, water production costs may be lowered through integration with a solar energy source or any other renewable energy source (such as wind) to cover the required electricity consumption. For thermal, desiccant-based AWG, integration with a solar thermal energy source or industrial waste heat source substantially lowers water production costs, as the relevant thermal energy requirements are thereby fulfilled and only a small amount of electricity is required to circulate moist ambient air during the adsorption phase.

There is no best method for AWG and selection of the most suitable process is essentially dependent on the performance and economical feasibility of the AWG solution that is to be implemented. Key variables for such selection include:
external atmospheric conditions (especially the relevant RH level), which dictate the amount of air moisture, which in turn affects water production rate and water recovery efficiency;
the degree of complexity of the AWG system to be implemented, which impacts capital expenditure (CAPEX) and operational expenditure (OPEX);
energy efficiency, i.e. the amount of energy required for efficient water recovery to increase overall system efficiency; and
the ability to integrate renewable energy sources to fulfil the relevant energy consumption requirements and thereby achieve sustainable AWG.

AWG systems/processes based on vapor compression are the most commonly available solutions on the market today. Such AWG systems/processes are also referred to as cooling condensation AWGs and in essence operate in a manner similar to a dehumidifier. More specifically, a compressor is typically used to circulate a refrigerant through a condenser and then through an evaporator coil which cools the air surrounding it. Moist air is drawn across an electrostatic air filter and directed towards the evaporator coil. Moist air surrounding the evaporator coil is cooled down below its dew point, causing water to condense. The resulting condensate is then collected into a tank before being pumped out of the system, usually through a purification and filtration system. During the vapor condensation process, heat from the moist air is transferred into the refrigerant via flow boiling of the refrigerant flowing through the evaporator coil. Evaporated refrigerant in saturated vapor phase is then channelled back to the compressor before being compressed to higher saturation pressure/temperature. The compressed vapor phase refrigerant then undergoes condensation in the condenser. Latent heat resulting from such condensation is transferred from the refrigerant into dry dehumidified air which is rejected into the environment.

The advantage of such a cooling condensation AWG resides in the fact that it is reasonably energy efficient when relative humidity (RH) of the ambient air exceeds 60%. The compressor however consumes a lot of energy, which means that, for lower ambient air RH levels, energy efficiency becomes an issue. Another drawback of this solution resides in the fact that it requires large volumes of air to be cooled below its dew point to harvest and condense the water vapor, rendering these systems highly energy intensive for certain low humidity ambient conditions.

AWG systems/processes based on thermal desiccation are used less widely but have great potential. Such technology essentially capitalizes on the use of adsorbent materials that are capable of inducing attraction and surface bonding of adsorbates, in this case water molecules. Water harvesting with such technology mainly involves three main phases, namely (i) an adsorption phase during which the adsorbent material is in essence cooled and fed with moist ambient air to induce bonding with the water molecules contained in the air, (ii) a desorption phase (also referred to as regeneration phase) during which the adsorbent material is heated to cause vaporization of the adsorbed water into water vapor, and (iii) a vapor condensation phase during which the water vapor is caused to condense into a condensate.

Known AWG solutions based on thermal desiccation are for instance disclosed in U.S. Pat. Nos. 4,146,372 A, 6,336,957 B1, 6,863,711 B2, 7,467,523 B2, 9,234,667 B1, 10,683,644 B2, and 10,835,861 B2.

Typical adsorbent materials include silica, silica gel, zeolites, alumina gel, molecular sieves, montmorillonite clay, activated carbon, hygroscopic salts, metal-organic frameworks (MOF) such as zirconium or cobalt based adsorbents, hydrophilic polymer or cellulose fibers, and derivatives of combinations thereof.

The advantage of thermal-desiccant-based AWG systems resides in the fact that they remain economically feasible even when deployed in regions with low RH levels. Furthermore, such solutions do not require any moving components such as compressors or pumps for refrigeration flow, which renders these solutions more robust and more cost-efficient to operate, and with higher performance durability.

There however remains a need for an improved solution.

### SUMMARY OF THE INVENTION

A general aim of the invention is to provide an atmospheric water generation system and related method that obviate the limitations and drawbacks of the prior art solutions.

More specifically, an aim of the present invention is to provide such a solution that is highly efficient and moreover cost-efficient to implement and operate.

A further aim of the invention is to provide such a solution that is modular and easily up-scalable to increase and adjust system throughput to the required needs.

Another aim of the invention is to provide such a solution that ensures efficient heat recovery and re-heat over multiple cycles for carrying out the desorption (regenerative) phase of the adsorbents.

Yet another aim of the invention is to provide such a solution that exhibits lower systemic energy consumption requirements (both electrical and thermal) and minimizes thermodynamic losses.

A further aim of the invention is to provide such a solution that can suitably be combined and integrated with renewable energy sources, in particular solar energy, and/or make optimal use of waste heat, for instance from industrial processes.

Still another aim of the invention is to possibly allow co-generation of both water and electricity in an energy-efficient manner.

These aims, and others, are achieved thanks to the solutions defined in the claims.

There is accordingly provided an atmospheric water generation system, the features of which are recited in claim 1, namely an atmospheric water generation system comprising at least one atmospheric water generation unit including:
at least two successive processing stages each including an adsorbent structure comprising an adsorbent material, which adsorbent structure is coupled to an adjacent vapor chamber to allow vapor transfer thereto;
a heating stage to provide thermal energy to the adsorbent structures;
a cooling stage to cause condensation of water vapor in at least a final one of the vapor chambers; and
a circuit to force circulation of moist ambient air through the adsorbent structures and cause adsorption of water in the adsorbent structures.

According to the invention, the at least one atmospheric water generation unit is configured to operate in a desorption mode where the heating stage is operated such that thermal energy provided by the heating stage causes water adsorbed in the adsorbent structures to be desorbed into water vapor, which water vapor transits to the adjacent vapor chamber where the water vapor condenses into a condensate.

Various preferred and/or advantageous embodiments of this atmospheric water generation system form the subject-matter of dependent claims 2 to 34.

Also claimed is the use of the atmospheric water generation system of the invention in combination with a solar energy harvesting system, wherein heat generated by the solar energy harvesting system is used as thermal energy source for the at least one atmospheric water generation unit. In this context, the solar energy harvesting system may in particular be a photovoltaic (PV) system, especially a concentrated photovoltaic (CPV) system.

There is further provided an atmospheric water generation method, the features of which are recited in independent claim 38, namely an atmospheric water generation method comprising the following steps:
(a) providing at least one atmospheric water generation unit including two or more successive processing stages each including an adsorbent structure comprising an adsorbent material, which adsorbent structure is coupled to an adjacent vapor chamber to allow vapor transfer thereto;
(b) forcing circulation of moist ambient air through the adsorbent structures to cause adsorption of water in the adsorbent structures;

(c) supplying thermal energy to the adsorbent structures to cause water adsorbed in the adsorbent structures to be desorbed into water vapor, which water vapor transits to the adjacent vapor chamber; and
(d) condensing the water vapor contained in the vapor chamber into a condensate.

Various preferred and/or advantageous embodiments of this atmospheric water generation method form the subject-matter of dependent claims 39 to 73. Further advantageous embodiments of the invention are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic diagram of an atmospheric water generation system (AWGS) in accordance with one embodiment of the invention;

FIG. 2 is a partial explanatory diagram illustrating operation of the AWGS of FIG. 1;

FIG. 3 is a partial schematic diagram of an AWGS in accordance with another embodiment of the invention;

FIG. 4 is a schematic diagram of an AWGS in accordance with yet another embodiment of the invention;

FIG. 5 is a partial schematic diagram of an AWGS in accordance with a further embodiment of the invention;

FIG. 6 is a partial schematic diagram of an AWGS in accordance with an additional embodiment of the invention;

FIGS. 7A and 7B are schematic diagrams respectively showing a top view and sectional view of an AWGS in accordance with yet another embodiment of the invention; and

FIG. 8 is a schematic diagram showing an AWGS making use of first and second atmospheric water generation units (AWGUs) operated side by side to ensure continued, uninterrupted production of water.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein.

As described herein, when two or more parts or components are described as being connected, attached, secured or coupled to one another, they can be so connected, attached, secured or coupled directly to each other or through one or more intermediary parts.

Embodiments of the atmospheric water generation system (AWGS)—and related method—of the invention will especially be described hereinafter in the particular context of an application thereof in combination with a solar energy harvesting system that provides a source of renewable thermal energy to drive the desorption phase. It will be appreciated that any other thermal energy source could be contemplated, including e.g. use of waste heat produced by industrial processes.

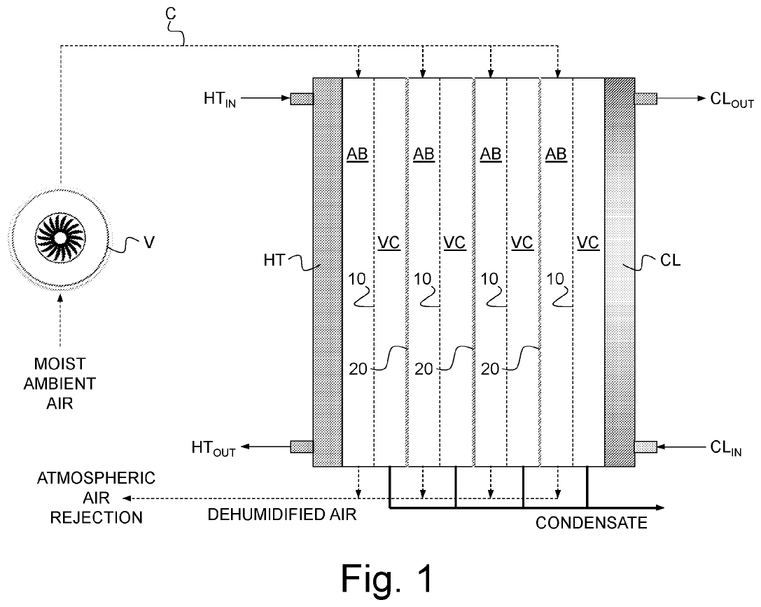

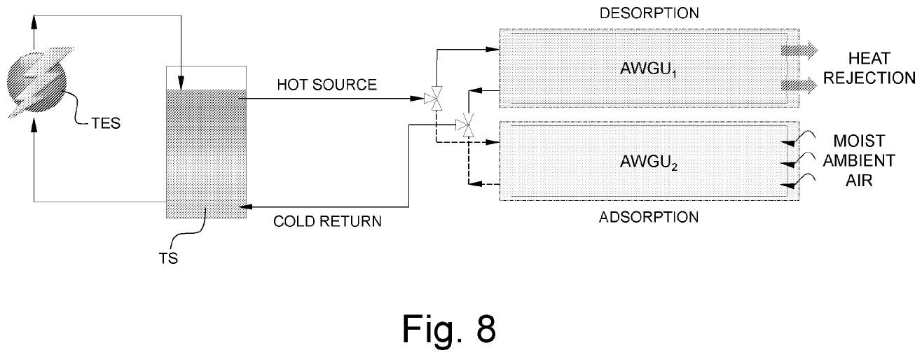

FIG. 1 is a schematic diagram of an AWGS in accordance with a first embodiment of the invention. A single atmospheric water generation unit (AWGU) is shown in FIG. 1, but it shall be understood that the AWGS could comprise multiple AWGUs, including first and second AWGUs designed to operate side by side and in a temperature swing configuration, as explained in greater detail hereafter with reference to FIG. 8.

Visible in FIG. 1 are a plurality of processing stages each including an adsorbent structure comprising an adsorbent material, which adsorbent structure is coupled to an adjacent vapor chamber to allow vapor transfer thereto. More specifically, in the illustrated example, each processing stage includes an adsorbent bed AB containing an adsorbent material, which adsorbent bed AB is coupled to an adjacent vapor chamber VC via a vapor permeable separation wall, designated by reference numeral 10.

The adsorbent material may be any suitable adsorbent material, including e.g. packed silica gel or zeolites. Other adsorbent materials could however be contemplated, including the adsorbent materials identified in the preamble hereof.

In the illustration of FIG. 1, four processing stages (also referred to as “effects”) are shown. More specifically, the four processing stages are distributed one after the other in sequence, and the vapor chamber VC of each preceding processing stage (i.e. the first three processing stages starting from the left in FIG. 1) is coupled to the adsorbent bed AB of a following processing stage (i.e. the last three processing stages starting from the left in FIG. 1) via a corresponding heat exchanger plate, designated by reference numeral 20. Three such heat exchanger plates 20 are accordingly shown in FIG. 1, namely between the first and second processing stages, between the second and third processing stages, and between the third and fourth processing stages.

The adsorbent bed AB of the first processing stage is coupled to a heat exchanger device HT, while the vapor chamber VC of the fourth and last processing stage is coupled to a cooling (or condenser) device CL. In the illustrated example, the heat exchanger device HT is flowed through by a suitable heating medium which is fed via a heating inlet HT_{IN} and exits the heat exchanger device HT via a heating outlet HT_{OUT}. The heating medium may be any suitable heating medium (such as a liquid) heated by an external thermal energy source. The cooling device CL is likewise flowed through by a suitable cooling medium (such as e.g. cold air) that is brought to a sufficiently low temperature to cause condensation of water vapor as discussed later. The cooling medium is fed to the cooling device CL via a cooling inlet CL_{IN} and exits the cooling device CL at a cooling outlet CL_{OUT}.

The AWGU shown schematically in FIG. 1 is operated cyclically in accordance with essentially two sequential phases, namely (i) an adsorption phase during which the adsorbent beds AB are (re)charged with water contained in moist ambient air and (ii) a desorption phase during which water adsorbed in the adsorbent beds AB is desorbed into water vapor. During the adsorption phase, the adsorbent beds AB are kept at a cool temperature (typically lower than 30° C.), while, during the desorption phase, the adsorbent beds AB are heated and brought to a temperature sufficient to cause vaporization of the water (typically to a temperature of approximately 80° C. to 90° C. or higher for enhanced regeneration/desorption).

Moist ambient air from which water is to be harvested is circulated through each of the adsorbent beds AB during the adsorption phase by means of a suitable air circuit C, which comprises, in the illustrated example, a suitable ventilator V to assist forced circulation of air through the adsorbent beds AB. Not shown in FIG. 1 are optional particle filters (such as High Efficiency Particulate Air—HEPA—filters) used to filter moist ambient air from any undesired dust or impurity to avoid clogging and contamination of the adsorbent material. Air is exiting the adsorbent beds AB as dehumidified air which is returned to the environment. It will be appreciated that the relevant direction in which ambient air circulates through the adsorbent beds AB is not critical and does not impact adsorption efficiency.

In the illustrated example, each of the vapor chambers VC is further provided with a drainage port to allow drainage by gravity of the condensate that condenses therein during the desorption phase. Such condensate can conveniently be collected in a suitable tank (not shown) for use as potable water after remineralization.

The vapor permeable separation wall 10 is designed to retain the adsorbent material contained in the associated adsorbent bed AB, while allowing water vapor produced during the desorption phase to permeate and enter the adjacent vapor chamber VC where condensation into the condensate occurs. The vapor permeable separation wall 10 is preferably a mesh or a perforated foil structure, in particular made of polymer or metal. Any suitable polymer or metallic material could be used. In particular, a thin non-corrosive perforated metallic foil made e.g. of steel or titanium could be used as vapor permeable separation wall 10, or a polymer mesh made e.g. of polytetrafluoroethylene (PTFE), polyoxymethylene (POM), polyvinyl chloride (PVC), polypropylene (PP) or polyurethane (PU).

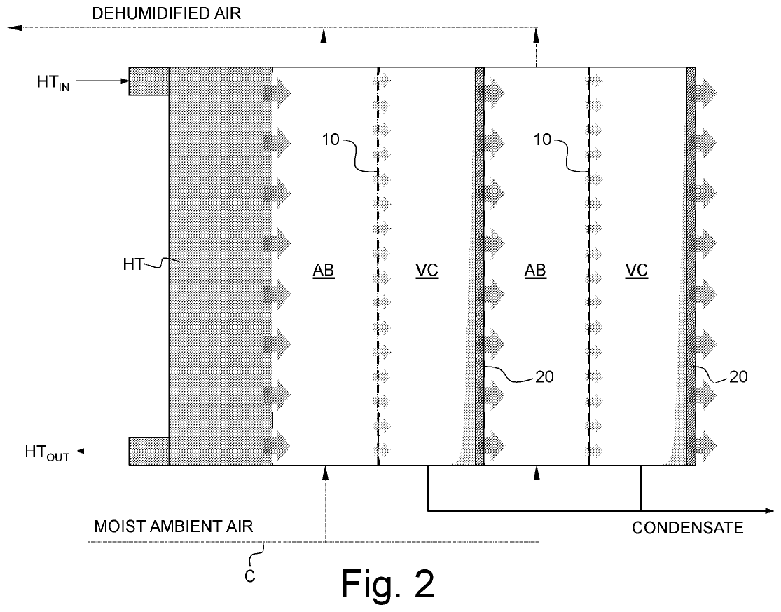

FIG. 2 is a partial explanatory diagram illustrating operation of the AWGS of FIG. 1. Only the first two processing stages/effects are shown in FIG. 2 for the sake of explanation, including adsorbent beds AB, vapor chambers VC, vapor permeable separation walls 10, and heat exchanger plates 20, and the associated heat exchanger device HT coupled to the first adsorbent bed AB.

During the desorption phase, low-grade thermal energy at approximately 80° C. to 90° C. (or higher) is supplied to the first adsorbent bed AB through the heat exchanger device HT that is coupled to a suitable thermal energy source (not shown). As already mentioned, such thermal energy source may be any suitable source, including heat generated by solar heat collectors or concentrated photovoltaic (CPV) systems, or industrial waste heat. Thermal energy supplied to the first adsorbent bed AB causes heating of the adsorbent material, thereby triggering desorption and vaporization of the water adsorbed thereby.

Desorbed water vapor is transported across the adsorbent material to the adjacent vapor chamber VC through the vapor permeable separation wall 10. Vapor condensation occurs along the surface of the heat exchanger plate 20, on the vapor chamber side, as schematically illustrated. Latent heat resulting from condensation of the condensate along the surface of the heat exchanger plate 20 is recovered to efficiently re-heat the adsorbent material located in the following (second) adsorbent bed AB. Such heat recovery is particularly advantageous in that this lowers thermal energy consumption, thereby improving energy usage efficiency.

The process repeats itself in similar fashion as one moves further to the following processing stages/effects, i.e. from left to right in the illustrated example. As shown in FIG. 1, four processing stages are used in the illustrated example. From a practical perspective, the integer number n of processing stages that may be contemplated may advantageously range from 2 to 10. The actual number of processing stages used in practice will be selected depending on, especially, the type of adsorbent material being used, as well as the prevailing atmospheric conditions and ambient temperatures in which the system is to be deployed. More stages/effects may for instance be required if ambient temperatures are low.

As already mentioned, condensate produced in the relevant vapor chambers VC is drained out of the system by gravity through a suitable drainage port provided at the bottom of each vapor chamber VC, which condensate can be used to produce water suitable for e.g. human consumption. Such condensate can especially be recovered and collected into one or more collection tanks (not shown). Optional purification of the condensate and/or remineralization thereof may be carried out prior to using the condensate as potable water.

During the adsorption phase, heating of the adsorbent beds AB is stopped, or the adsorbent beds AB are cooled, while moist ambient air is fed therethrough, to ensure optimal adsorption efficiency and (re) charging of the adsorbent beds AB with water for subsequent, renewed desorption. By way of preference, temperature of the adsorbent beds AB during the adsorption phase does not exceed 30° C. Dehumidified air exiting the adsorbent beds AB is then rejected back into the atmosphere.

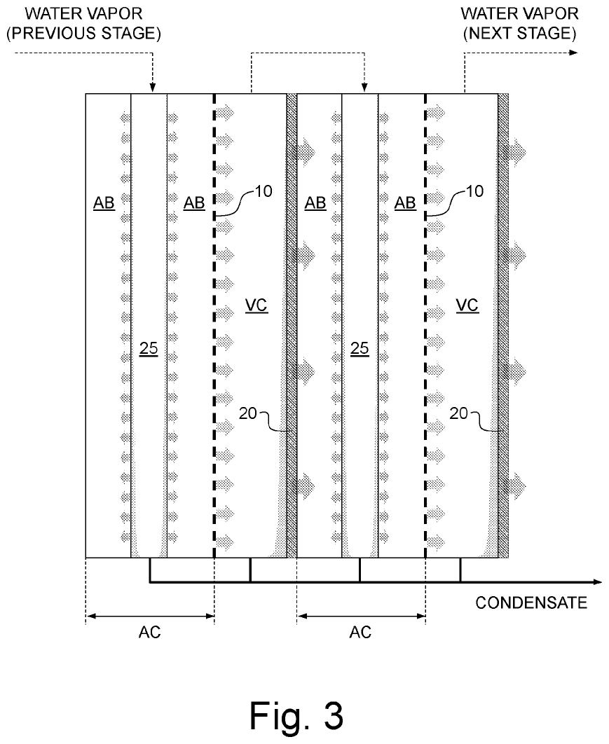

FIG. 3 is a partial schematic diagram of an AWGS in accordance with another embodiment of the invention. Only part of the relevant AWGU is shown in FIG. 3, including two subsequent processing stages/effects thereof. The configuration of the AWGU shown in FIG. 3 is in essence similar to that of the AWGU shown in FIGS. 1 and 2. The same reference signs and numerals designate the same components as already described above. One can accordingly identify, for each processing stage/effect, an adsorbent bed AB coupled to an adjacent vapor chamber VC via a vapor permeable separation wall 10, as well as a heat exchanger plate 20 interposed between the vapor chamber VC of the first processing stage and the adsorbent bed AB of the second processing stage. A further heat exchanger plate 20 is provided on the downstream end of the vapor chamber VC of the second processing stage.

Visible in FIG. 3 are two heat transfer tubes 25 than extend through the two adsorbent beds AB. Each heat transfer tube 25 is designed to supply thermal energy to the relevant adsorbent bed AB. In effect, each adsorbent bed AB and associated heat transfer tube 25 form a corresponding adsorbent chamber AC adjacent the associated vapor chamber VC. One or more such heat transfer tubes 25 could be provided within each adsorbent bed AB.

By way of preference, as schematically shown in FIG. 3, thermal energy is supplied to the adsorbent beds AB thanks to circulation of the water vapor coming from the previous stage of the AWGU. In a manner similar to the heat exchanger plates 20, water vapor condenses along the inner walls of the heat transfer tubes 25 causing release of latent heat that is recovered to heat the adsorbent material located in the surrounding adsorbent bed AB. This solution serves to reduce thermal resistance and enhance the (re-)heat and regeneration process of the adsorbent material. This once again lowers thermal energy consumption, thereby further improving energy usage efficiency.

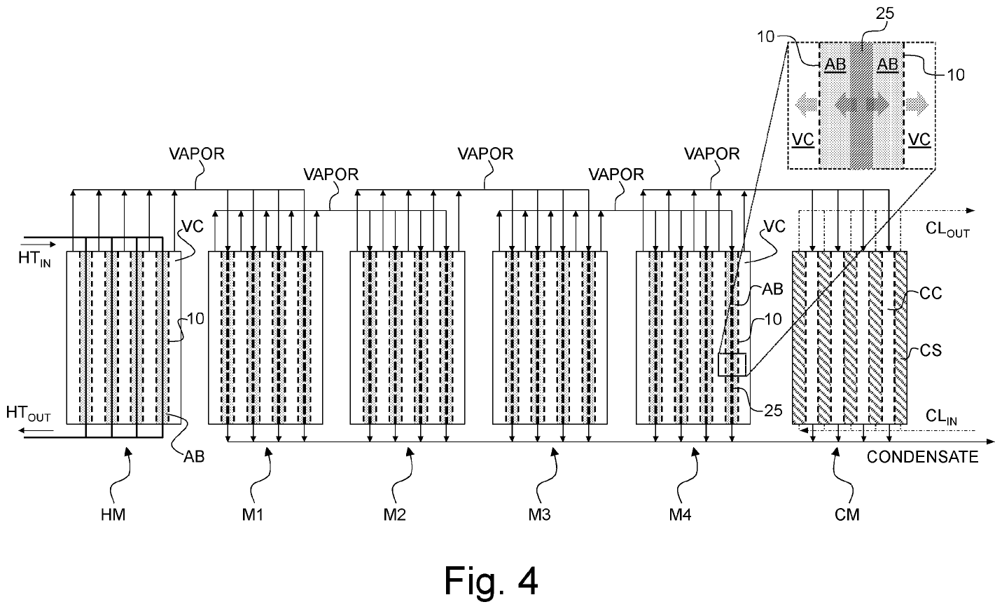

FIG. 4 is a schematic diagram of an AWGS in accordance with yet another embodiment of the invention. In contrast to the previous embodiments, the relevant AWGU is constructed of multiple modules per stage/effect, designated HM, M1 to M4 and CM. Module HM is a heating module, acting as heating stage of the AWGU, while modules M1 to M4 are successive processing modules that are fed in sequence with water vapor coming from the preceding modules, namely heating module HM and processing modules M1 to M3. Module CM is a condenser module, acting as cooling stage of the AWGU, that is fed by the water vapor coming from the preceding processing module, namely the fourth and last processing module M4.

In the illustrated example, each processing module M1-M4 includes a plurality of (namely four) adsorbent beds AB that are interposed between a plurality of (namely five) vapor chambers VC. A vapor permeable separation wall 10 is likewise provided at the interface between each adsorbent bed AB and adjacent vapor chambers VC.

In a manner similar to the heat exchanger device HT, heating module HM is designed to supply thermal energy to the system and is flowed through by a suitable heating medium which is fed via a heating inlet HT_{IN} and exits the heating module HM via a heating outlet HT_{OUT}. In the illustrated example, the heating module HM exhibits a configuration that is substantially similar to that of the processing modules M1-M4 and likewise includes a plurality of (namely four) adsorbent beds AB that are interposed between a plurality of (namely five) vapor chambers VC. A vapor permeable separation wall 10 is once again provided at the interface between each adsorbent bed AB and adjacent vapor chambers VC. The heating medium is fed via heating tubes extending through each of the adsorbent beds AB to trigger desorption. The resulting water vapor likewise permeates through the vapor permeable separation wall 10 into the adjacent vapor chambers VC.

In the illustrated example, water vapor coming from the vapor chambers VC of the heating module HM is fed to heat transfer tubes 25 extending through each adsorbent bed AB of the first processing module M1. Similarly, water vapor coming from the vapor chambers VC of the first processing module M1 is fed to heat transfer tubes 25 extending through each adsorbent bed AB of the second processing module M2, and so on until the fourth and last processing module M4.

At the downstream end of the AWGU, water vapor coming from the vapor chambers VC of the last processing module M4 is fed to condensation chambers CC of the condenser module CM. More specifically, a plurality of (namely four) condensation chambers CC are provided that are interposed between a plurality of (namely five) cooling sections CS.

In a manner similar to the cooling device CL shown in FIG. 1, the condenser module CM is flowed through by a suitable cooling medium that is brought to a sufficiently low temperature to cause condensation of water vapor inside the condensation chambers CC. The cooling medium is fed to the cooling module CM via a cooling inlet CL_{IN} and exits the cooling module CM at a cooling outlet CL_{OUT}, the cooling medium circulating through each of the cooling sections CS to ensure optimal condensation efficiency.

As shown in FIG. 4, each processing module M1-M4 comprises a sequence of four adsorbent beds interposed between five adjacent vapor chambers VC, each adsorbent bed AB being surrounded by a pair of adjacent vapor chambers VC. From a practical perspective, the integer number n of adsorbent beds AB that may be contemplated may advantageously range from 2 to 6, but a greater number of adsorbent beds AB (and adjacent vapor chambers VC) could possibly be contemplated.

By the same token, while FIG. 4 shows a sequence of four processing modules M1-M4, the number of processing modules that may be contemplated could vary. From a practical perspective, the integer number m of processing modules will preferably range from 2 to 10. The actual number of processing modules used in practice will once again be selected depending on, especially, the type of adsorbent material being used, as well as the prevailing atmospheric conditions and ambient temperatures in which the system is to be deployed. More modules/effects may for instance be required if ambient temperatures are low.

As shown in FIG. 4, one may note that drainage of the condensate occurs via drainage ports provided at the bottom of the heat transfer tubes 25 extending through the adsorbent beds AB of the processing modules M1-M4 and at the bottom of the condensation chambers CC of the condenser module CM.

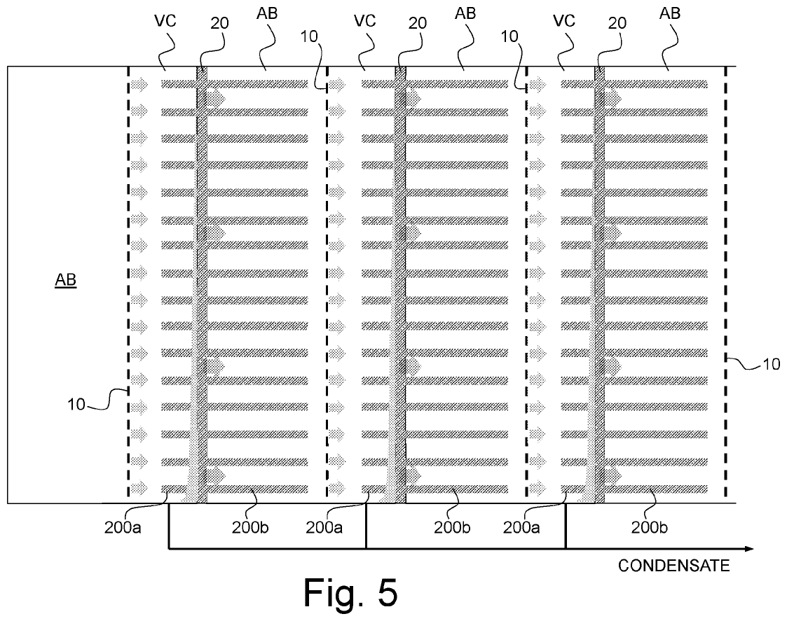

FIG. 5 schematically shows another embodiment of the invention. Only part of the relevant AWGU is shown in FIG. 5. The configuration of the AWGU shown in FIG. 5 is in essence similar to that of the AWGU shown in FIGS. 1 and 2. The same reference signs and numerals designate the same components as already described above. One can accordingly identify, for each processing stage/effect, an adsorbent bed AB coupled to an adjacent vapor chamber VC via a vapor permeable separation wall 10, as well as heat exchanger plates 20 interposed between the vapor chamber VC of the preceding processing stage and the adsorbent bed AB of the following processing stage.

The AWGU shown in FIG. 5 differs from the embodiment shown in FIGS. 1 and 2 in that each heat exchanger plate 20 is provided with a plurality of protruding heat transfer elements 200a, 200b extending from the heat exchanger plate 20 into the vapor chamber VC of the preceding processing stage and into the adsorbent bed AB of the following processing stage. The protruding heat transfer elements 200a, 200b may in particular include protruding fins, pins or heat pipes. In other embodiments, the protruding heat transfer elements may extend only into the vapor chamber VC or into the adsorbent bed AB, but the illustrated configuration is preferable. The heat transfer elements 200a on the vapor chamber VC side have a beneficial effect with regard to condensation and transfer of the resulting latent heat. The heat transfer elements 200b on the adsorbent bed AB side also have a beneficial effect in that heat distribution is improved, which translates into better desorption efficiency.

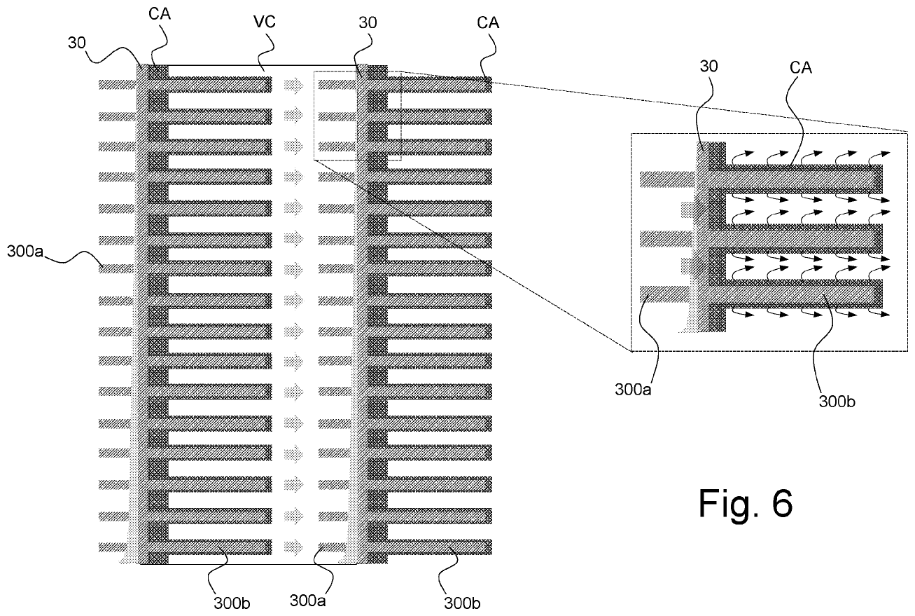

FIG. 6 schematically shows yet another embodiment of the invention, only part of the relevant AWGU being again shown. The configuration of the AWGU depicted in FIG. 6 bears some similarities with that of FIG. 5, but also notable differences. The main difference resides in the fact that the adsorbent structure here includes a coated adsorbent layer, designated by reference sign CA, which is provided on a side of a heat transfer structure 30/300a/300b in the adjacent vapor chamber VC. In other words, no vapor permeable separation wall is required in this instance, and the adsorbent material is formed directly onto the relevant side of the heat transfer structure 30/300a/300b as a coated layer. One may note that the heat transfer structure 30/300a/300b of FIG. 6 is similar in configuration to the heat exchanger structure 20/200a/200b shown in FIG. 5. Indeed, the heat transfer structure 30/300a/300b of FIG. 6 similarly consists of a heat exchanger plate 30 that is provided with protruding heat transfer elements 300a, 300b extending on both sides, such as protruding fins, pins or heat pipes. The heat transfer elements 300a likewise extend into the adjacent vapor chamber VC to improve condensation as well as transfer of the resulting latent heat, while the heat transfer elements 300b (which act as supportive structure for the coated adsorbent layer CA) improve heat distribution and therefore desorption efficiency.

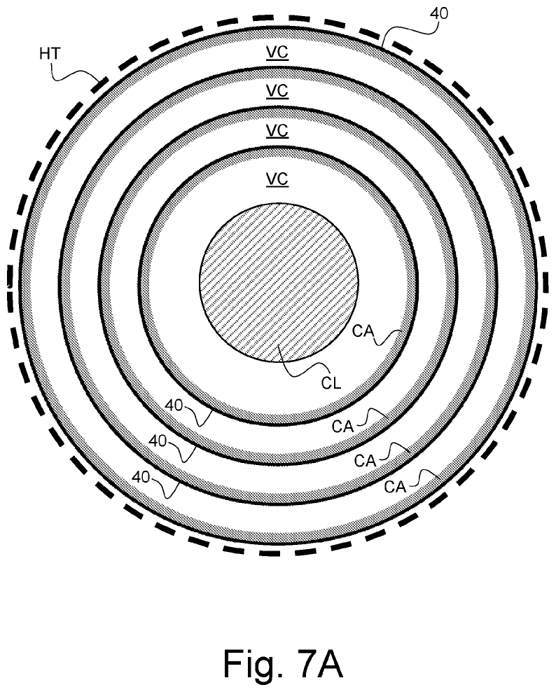

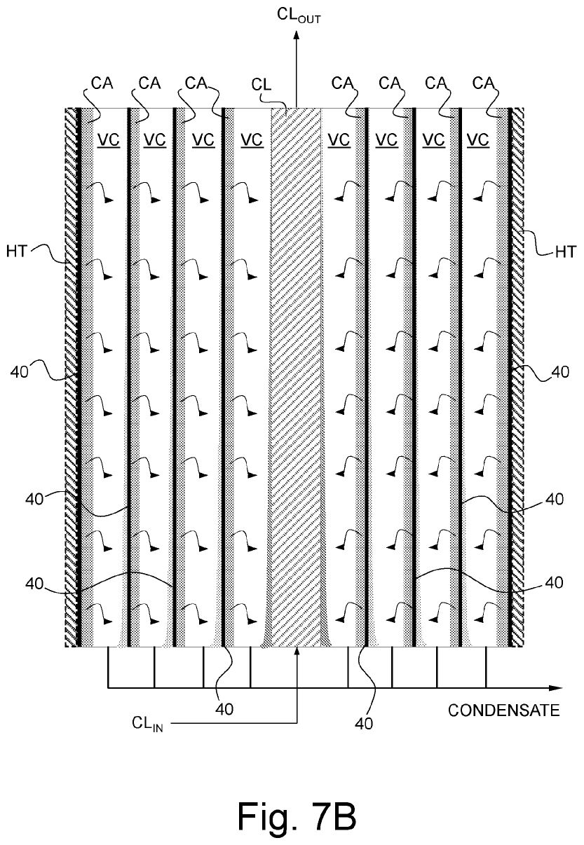

One will appreciate that the use of coated adsorbent layers CA as adsorbent structures does not however necessitate implementation of protruding heat transfer elements as shown in FIG. 6. The coated adsorbent layer CA could for instance be formed on the surface of a heat exchanger plate devoid of any protruding elements as for instance illustrated by the embodiment shown in FIGS. 7A-B.

The AWGU shown in FIGS. 7A-B is constructed as an essentially circular structure with multiple (namely four) processing stages/effects CA/VC consisting of concentric sections. More specifically, a heat exchanger device HT is provided at the outmost side to transfer heat to the adsorbent structures, namely to the coated adsorbent layer CA of a first one of the processing stages CA/VC, via the heat exchanger plate 40 onto which the coated adsorbent layer CA is provided. Heat is transferred in succession, towards the center of the structure, to the other processing stages through the same principle as described before, namely by exploiting latent heat resulting from condensation of the water vapor along the exterior surface of each heat exchanger plate 40 to (re-)heat the coated adsorbent layer CA provided on the other side of the heat exchanger plate 40. In the central portion of the AWGU, there is likewise provided a cooling device CL that is flowed through by a suitable cooling medium to cause condensation of water vapour in the vapor chamber VC of the fourth and final processing stage.

In accordance, with a particularly advantageous implementation of the invention (which is applicable to all embodiments discussed herein), the atmospheric water generation unit, comprising all of the adsorbent structures AB, resp. CA and vapor chambers VC are maintained in a partial vacuum condition by means of a suitable low pressure system. Ideally, pressure in the adsorbent structures AB, resp. CA and vapor chambers VC is lowered down to a pressure of 5 kPa (0.05 bar) or less during the desorption phase to facilitate desorption and vapor condensation, thereby improving desorption efficiency and enhancing condensation. In particular, a suitable vacuum pump may be connected to the one or more collection tanks that are used to collect the condensate in order to reduce overall system pressure and lower vapor transport resistance during desorption.

FIG. 8 is a schematic diagram showing an AWGS making use of first and second AWGUs, respectively designated as units AWGU₁ and AWGU₂, that are operated side by side to ensure continued, uninterrupted production of water. More specifically, the first unit AWGU₁ and the second unit AWGU₂ are designed to operate in a temperature swing configuration. In other words, the first unit AWGU₁ is configured to operate in the desorption mode during a first cycle (such as during the day), thus rejecting heat, while the second unit AWGU₂ is configured to operate in the adsorption mode, thus recharging the adsorbent structures with water. Conversely, the first unit AWGU₁ is configured to be switched to the adsorption mode during another cycle (such as during the night), while the second unit AWGU₂ is configured to be switched to the desorption mode. Operation of the first unit AWGU₁ and the second unit AWGU₂ is thus alternated, every given cycle, to ensure continued production of water.

As shown in FIG. 8, the first unit AWGU₁ and the second unit AWGU₂ are advantageously coupled to a thermal storage device TS. The thermal storage device TS could be any suitable device capable of storing heat energy, such as a device comprising a material capable of undergoing a phase change (or so-called “Phase-Change Material”/PCM) and performing so-called “Latent Heat Storage” (LHS). A multitude of PCMs are available, including e.g. salts, polymers, gels, paraffin waxes and metal alloys. Other suitable solutions may rely on materials capable of performing so-called “Sensible Heat Storage” (SHS), such as molten salts or metals. “Thermo-chemical Heat Storage” (TCS) constitutes yet another possible solution to perform thermal energy storage.

In the illustrated example, a hot source coming from the thermal storage device TS is supplied to the relevant one of the two units AWGU₁, AWGU₂ being operated in the desorption mode, using the hot source to sustain desorption. The comparatively colder medium being retrieved from the relevant unit operating in the desorption mode is returned to the thermal storage device TS. As shown in FIG. 8, the hot source and cold return are adequately routed to and from the relevant one of the two units by means of a suitable valve system.

The required thermal energy to adequately sustain desorption may be stored and maintained in the thermal storage device TS, subject to being renewed by an associated, preferably renewable, thermal energy source TES. In that respect, the thermal energy source TES may ideally originate from solar energy or industrial waste heat processes. By way of preference, the thermal energy source TES may be generated by an associated solar energy harvesting system, including a photovoltaic (PV) system. A concentrated photovoltaic (CPV) system may ideally play that function, as CPV systems typically generate heat that needs to be extracted. In that regard, one may appreciate that heat extracted from e.g. a CPV system by an appropriate cooling apparatus or heat extraction apparatus could be reused as driving force to sustain desorption in the AWGS of the invention.

Various modifications and/or improvements may be made to the above-described embodiments without departing from the scope of the invention as defined by the appended claims.

For instance, as mentioned above, any adequate thermal energy source may be used to drive and sustain desorption in the context of the AWGS of the invention. Renewable energy sources, such as solar energy, or any source of waste heat, such as waste heat originating from industrial processes, could especially come into consideration.

### LIST OF REFERENCE NUMERALS AND SIGNS USED THEREIN

AB adsorbent structures/adsorbent beds containing adsorbent material (such as packed silica gel or zeolites)
VC vapor chamber adjacent adsorbent bed(s) AB
AC adsorbent chambers
10 vapor permeable separation wall (e.g. polymer mesh) interposed between adsorbent bed AB and adjacent vapor chamber VC
20 heat exchanger plate interposed between vapor chamber of preceding processing stage AB/VC and adsorbent bed of following processing stage AB/VC
200a protruding heat transfer elements provided on heat exchanger plate 20 and extending into adjacent vapor chamber VC
200b protruding heat transfer elements provided on heat exchanger plate 20 and extending into adjacent adsorbent bed AB
25 heat transfer tube(s) extending through adsorbent bed AB
CA adsorbent structures/coated adsorbent layers of adsorbent material
30 heat exchanger plate carrying coated adsorbent layer CA on one side
300a protruding heat transfer elements provided on heat exchanger plate 30 and extending into adjacent vapor chamber VC of preceding processing stage
300b protruding heat transfer elements provided on heat exchanger plate 30 and carrying coated adsorbent layer CA
40 heat exchanger plate carrying coated adsorbent layer CA on one side
C circuit for forced circulation of moist ambient air through adsorbent C structures AB, resp. CA
V ventilator
HT heat exchanger device (heating stage) coupled to adsorbent structure of first processing stage AB/VC, resp. CA/VC
CL cooling device (cooling stage) coupled to vapor chamber VC of last processing stage AB/VC, resp. CA/VC
M1 (first) processing module
M2 (second) processing module
M3 (third) processing module
M4 (fourth/last) processing module
HM heating module (heating stage)
CM condenser module (cooling stage)
CC condensation chambers of condenser module CM
CS cooling sections of condenser module CM
HT_{IN} heating inlet of heating stage HT, resp. HM
HT_{OUT} heating outlet of heating stage HT, resp. HM
CL_{IN} cooling inlet of cooling stage CL, resp. CM
CL_{OUT} cooling outlet of cooling stage CL, resp. CM
AWGU₁ (first) atmospheric water generation unit
AWGU₂ (second) atmospheric water generation unit
TS thermal storage device
TES thermal energy source (e.g. thermal energy produced by solar energy harvesting system or coming from industrial waste heat source)

1.-73. (canceled)

74. An atmospheric water generation system comprising at least one atmospheric water generation unit including:
at least two successive processing stages each including an adsorbent structure comprising an adsorbent material, wherein the adsorbent structure is coupled to an adjacent vapor chamber to allow vapor transfer thereto;
a heating stage to provide thermal energy to the adsorbent structures;
a cooling stage to cause condensation of water vapor in at least a final one of the vapor chambers; and
a circuit to force circulation of moist ambient air through the adsorbent structures and cause adsorption of water in the adsorbent structures,
wherein the at least one atmospheric water generation unit is configured to operate in a desorption mode where the heating stage is operated such that thermal energy provided by the heating stage causes water adsorbed in the adsorbent structures to be desorbed into water vapor, and wherein the water vapor transits to the adjacent vapor chamber where the water vapor condenses into a condensate.

75. The atmospheric water generation system according to claim 74, wherein the at least one atmospheric water generation unit is configured such that latent heat resulting from condensation of the water vapor generated by a preceding processing stage is transferred to the adsorbent structure of a following processing stage to sustain desorption.

76. The atmospheric water generation system according to claim 74, wherein the adsorbent structure includes an adsorbent bed containing the adsorbent material, and wherein the adsorbent bed is coupled to the adjacent vapor chamber via a vapor permeable separation wall.

77. The atmospheric water generation system according to claim 76, wherein the processing stages are distributed one after the other in sequence,
wherein the vapor chamber of a preceding processing stage is coupled to the adsorbent bed of a following processing stage via a heat exchanger plate to cause condensation of the water vapor along a surface of the heat exchanger plate,
and wherein the heat exchanger plate is configured such that latent heat resulting from condensation of the water vapor along the surface of the heat exchanger plate on a vapor chamber side is transferred to the adsorbent bed of the following processing stage.

78. The atmospheric water generation system according to claim 77, comprising a sequence of n processing stages, n being an integer number comprised between 2 and 10.

79. The atmospheric water generation system according to claim 77, wherein the heating stage includes a heat exchanger device coupled to the adsorbent bed of a first one of the processing stages to supply thermal energy to the adsorbent material contained therein,
and wherein the cooling stage includes a cooling device coupled to the vapor chamber of a last one of the processing stages to cause condensation of the water vapor contained therein.

80. The atmospheric water generation system according to claim 77, wherein the heat exchanger plate is provided with a plurality of protruding heat transfer elements extending from the heat exchanger plate into the vapor chamber of the preceding processing stage and/or into the adsorbent bed of the following processing stage.

81. The atmospheric water generation system according to claim 80, wherein the protruding heat transfer elements include protruding fins, pins or heat pipes.

82. The atmospheric water generation system according to claim 76, further comprising one or more heat transfer tubes extending through at least one of the adsorbent beds to supply thermal energy to the adsorbent material contained therein.

83. The atmospheric water generation system according to claim 82, wherein the one or more heat transfer tubes is or are fed with water vapor coming from a preceding stage of the at least one atmospheric water generation unit,
and wherein each heat transfer tube is configured such that latent heat resulting from condensation of the water vapor along inner walls of the heat transfer tube is transferred to the surrounding adsorbent bed.

84. The atmospheric water generation system according to claim 76, wherein the at least one atmospheric water generation unit comprises a plurality of processing modules distributed one after the other in sequence, each processing module including a plurality of the adsorbent beds interposed between a plurality of the adjacent vapor chambers,
wherein each processing module further includes one or more heat transfer tubes extending through each of the adsorbent beds to supply thermal energy to the adsorbent material contained therein,
wherein the heat transfer tubes of each processing module are fed with water vapor coming from the vapor chambers of a preceding module of the atmospheric water generation unit,
wherein each heat transfer tube is configured such that latent heat resulting from condensation of the water vapor along inner walls of the heat transfer tube is transferred to the surrounding adsorbent bed,
and wherein the vapor chambers of each processing module feed water vapor to a following module of the atmospheric water generation unit.

85. The atmospheric water generation system according to claim 84, further comprising a heating module located immediately before the plurality of processing modules and a condenser module located immediately after the plurality of processing modules,
wherein the heating module includes a plurality of the adsorbent beds interposed between a plurality of the adjacent vapor chambers,
wherein the heat transfer tubes of a first one of the plurality of processing modules are fed with water vapor coming from the vapor chambers of the heating module,
and wherein the condenser module includes a plurality of condensation chambers that are fed with water vapor coming from the vapor chambers of a last one of the plurality of processing modules.

86. The atmospheric water generation system according to claim 84, wherein each processing module comprises a sequence of n adsorbent beds interposed between n+1 adjacent vapor chambers, n being an integer number comprised between 2 and 6.

87. The atmospheric water generation system according to claim 84, wherein the at least one atmospheric water generation unit comprises a sequence of m processing modules, m being an integer number comprised between 2 and 10.

88. The atmospheric water generation system according to claim 82, wherein each heat transfer tube includes a drainage port for drainage of the condensate condensing therein.

89. The atmospheric water generation system according to claim 76, wherein the vapor permeable separation wall consists of a mesh or perforated foil structure.

90. The atmospheric water generation system according to claim 89, wherein the mesh or perforated foil structure is made of polymer or metal.

91. The atmospheric water generation system according to claim 74, wherein the adsorbent structure includes a coated adsorbent layer provided on a side of a heat transfer structure in the adjacent vapor chamber.

92. The atmospheric water generation system according to claim 91, wherein the processing stages are distributed one after the other in sequence,
wherein the vapor chamber of a preceding processing stage is coupled to the coated adsorbent layer of a following processing stage via the heat transfer structure to cause condensation of the water vapor along a surface of the heat transfer structure,
and wherein the heat transfer structure is configured such that latent heat resulting from condensation of the water vapor along the surface of the heat transfer structure on a vapor chamber side is transferred to the coated adsorbent layer of the following processing stage.

93. The atmospheric water generation system according to claim 92, comprising a sequence of n processing stages, n being an integer number comprised between 2 and 10.

94. The atmospheric water generation system according to claim 92, wherein the heating stage includes a heat exchanger device coupled to the heat transfer structure of a first one of the processing stages to supply thermal energy to the adsorbent material of the associated coated adsorbent layer,
and wherein the cooling stage includes a cooling device coupled to the vapor chamber of a last one of the processing stages to cause condensation of the water vapor contained therein.

95. The atmospheric water generation system according to claim 92, wherein the heat transfer structure includes a heat exchanger plate provided with a plurality of protruding heat transfer elements extending from the heat exchanger plate into the vapor chamber of the preceding processing stage and/or into the vapor chamber of the following processing stage where the coated adsorbent layer is provided.

96. The atmospheric water generation system according to claim 95, wherein the protruding heat transfer elements include protruding fins, pins or heat pipes.

97. The atmospheric water generation system according to claim 74, wherein part or all of the vapor chambers includes/include a drainage port for drainage of the condensate condensing therein.

98. The atmospheric water generation system according to claim 74, wherein the adsorbent material includes packed silica gel or zeolites.

99. The atmospheric water generation system according to claim 74, wherein the heating stage is configured to be operated, when the at least one atmospheric water generation unit is operating in the desorption mode, to heat the adsorbent structures to a temperature of approximately 80° C. to 90° C. or higher.

100. The atmospheric water generation system according to claim 74, wherein the at least one atmospheric water generation unit is further configured to operate in an adsorption mode where the heating stage is operated such that heating of the adsorbent structures is stopped or such that the heating stage is used to cool the adsorbent structures.

101. The atmospheric water generation system according to claim 100, wherein the heating stage is configured to be operated, when the at least one atmospheric water generation unit is operating in the adsorption mode, such that the temperature of the adsorbent structures does not exceed 30° C.

102. The atmospheric water generation system according to claim 100, comprising first and second atmospheric water generation units in side-by-side operation,
wherein the first atmospheric water generation unit is configured to operate in the desorption mode during a first cycle, while the second atmospheric water generation unit is configured to operate in the adsorption mode,
and wherein the first atmospheric water generation unit is configured to be switched to the adsorption mode during a second cycle, while the second atmospheric water generation unit is configured to be switched to the desorption mode.

103. The atmospheric water generation system according to claim 74, wherein the at least one atmospheric water generation unit is coupled to a thermal storage device.

104. The atmospheric water generation system according to claim 74, wherein the at least one atmospheric water generation unit is coupled to a thermal energy source originating from solar energy or industrial waste heat processes.

105. The atmospheric water generation system according to claim 74, further comprising a low-pressure system to maintain the at least one atmospheric water generation unit in a partial vacuum condition during desorption.

106. The atmospheric water generation system according to claim 105, wherein the low-pressure system comprises a vacuum pump connected to one or more collection tanks collecting the condensate to reduce overall system pressure in the adsorbent structures and vapor chambers.

107. The atmospheric water generation system according to claim 105, wherein the low-pressure system is configured to lower pressure in the adsorbent structures and vapor chambers during desorption to a pressure of 5 kPa or less.

108. Use of the atmospheric water generation system according to claim 74 in combination with a solar energy harvesting system, wherein heat generated by the solar energy harvesting system is used as thermal energy source for the at least one atmospheric water generation unit.

109. Use according to claim 108, wherein the solar energy harvesting system is a photovoltaic system.

110. Use according to claim 109, wherein the photovoltaic system is a concentrated photovoltaic system.

111. An atmospheric water generation method comprising the following steps:
(a) providing at least one atmospheric water generation unit including two or more successive processing stages each including an adsorbent structure comprising an adsorbent material, wherein the adsorbent structure is coupled to an adjacent vapor chamber to allow vapor transfer thereto;
(b) forcing circulation of moist ambient air through the adsorbent structures to cause adsorption of water in the adsorbent structures;
(c) supplying thermal energy to the adsorbent structures to cause water adsorbed in the adsorbent structures to be desorbed into water vapor, wherein the water vapor transits to the adjacent vapor chamber; and
(d) condensing the water vapor contained in the vapor chamber into a condensate.

112. The atmospheric water generation method according to claim 111, wherein latent heat resulting from condensation of the water vapor generated by a preceding processing stage is transferred to the adsorbent structure of a following processing stage to sustain desorption.

113. The atmospheric water generation method according to claim 111, wherein the adsorbent structure includes an adsorbent bed containing the adsorbent material, and wherein the adsorbent bed is coupled to the adjacent vapor chamber via a vapor permeable separation wall.

114. The atmospheric water generation method according to claim 113, wherein the processing stages are distributed one after the other in sequence,
wherein the vapor chamber of a preceding processing stage is coupled to the adsorbent bed of a following processing stage via a heat exchanger plate,
wherein condensation of the water vapor at step (d) occurs along a surface of the heat exchanger plate,
and wherein latent heat resulting from condensation of the water vapor along the surface of the heat exchanger plate on a vapor chamber side is transferred to the adsorbent bed of the following processing stage.

115. The atmospheric water generation method according to claim 114, wherein step (a) includes providing a sequence of n processing stages, n being an integer number comprised between 2 and 10.

116. The atmospheric water generation method according to claim 114, wherein step (c) includes heating the adsorbent bed of a first one of the processing stages to supply thermal energy to the adsorbent material contained therein,
and wherein step (d) includes cooling the vapor chamber of a last one of the processing stages to cause condensation of the water vapor contained therein.

117. The atmospheric water generation method according to claim 114, wherein the heat exchanger plate is provided with a plurality of protruding heat transfer elements extending from the heat exchanger plate into the vapor chamber of the preceding processing stage and/or into the adsorbent bed of the following processing stage.

118. The atmospheric water generation method according to claim 117, wherein the protruding heat transfer elements include protruding fins, pins or heat pipes.

119. The atmospheric water generation method according to any one of claims 113, wherein step (a) includes providing one or more heat transfer tubes extending through at least one of the adsorbent beds,
and wherein step (c) includes supplying thermal energy to the adsorbent bed via the one or more heat transfer tubes.

120. The atmospheric water generation method according to claim 119, wherein step (c) includes feeding water vapor coming from a preceding stage of the at least one atmospheric water generation unit to the one or more heat transfer tubes,
and wherein latent heat resulting from condensation of the water vapor along inner walls of each heat transfer tube is transferred to the surrounding adsorbent bed.

121. The atmospheric water generation method according to claim 113, wherein step (a) includes providing a plurality of processing modules distributed one after the other in sequence, each processing module including a plurality of the adsorbent beds interposed between a plurality of the adjacent vapor chambers,
wherein step (a) further includes providing one or more heat transfer tubes extending through each of the adsorbent beds of each processing module,
wherein step (c) includes supplying thermal energy to the adsorbent beds of each processing module by feeding water vapor coming from a preceding module of the at least one atmospheric water generation unit to the heat transfer tubes,
wherein latent heat resulting from condensation of the water vapor along inner walls of each heat transfer tube is transferred to the surrounding adsorbent bed,
and wherein step (c) further includes feeding water vapor coming from the vapor chambers of each processing module to a following module of the at least one atmospheric water generation unit.

122. The atmospheric water generation method according to claim 121, wherein step (a) includes further providing a heating module located immediately before the plurality of processing modules and a condenser module located immediately after the plurality of processing modules,
wherein the heating module includes a plurality of the adsorbent beds interposed between a plurality of the adjacent vapor chambers,
wherein step (c) includes feeding the heat transfer tubes of a first one of the plurality of processing modules with water vapor coming from the vapor chambers of the heating module,
wherein the condenser module includes a plurality of condensation chambers,
and wherein step (d) includes feeding the condensation chambers of the condenser module with water vapor coming from the vapor chambers of a last one of the plurality of processing modules.

123. The atmospheric water generation method according to claim 121, wherein each processing module comprises a sequence of n adsorbent beds interposed between n+1 adjacent vapor chambers, n being an integer number comprised between 2 and 6.

124. The atmospheric water generation method according to claim 121, wherein step (a) includes providing a sequence of m processing modules, m being an integer number comprised between 2 and 10.

125. The atmospheric water generation method according to any one of claims 119, wherein step (d) includes draining the condensate condensing in each heat transfer tube via a drainage port.

126. The atmospheric water generation method according to claim 113, wherein the vapor permeable separation wall consists of a mesh or perforated foil structure.

127. The atmospheric water generation method according to claim 126, wherein the mesh or perforated foil structure is made of polymer or metal.

128. The atmospheric water generation method according to claim 111, wherein the adsorbent structure includes a coated adsorbent layer provided on a side of a heat transfer structure in the adjacent vapor chamber.

129. The atmospheric water generation method according to claim 128, wherein the processing stages are distributed one after the other in sequence,
wherein the vapor chamber of a preceding processing stage is coupled to the coated adsorbent layer of a following processing stage via the heat transfer structure,
wherein condensation of the water vapor at step (d) occurs along a surface of the heat transfer structure,
and wherein latent heat resulting from condensation of the water vapor along the surface of the heat transfer structure on a vapor chamber side is transferred to the coated adsorbent layer of the following processing stage.

130. The atmospheric water generation method according to claim 129, wherein step (a) includes providing a sequence of n processing stages, n being an integer number comprised between 2 and 10.

131. The atmospheric water generation method according to claim 129, wherein step (c) includes heating the coated adsorbent layer of a first one of the processing stages to supply thermal energy to the adsorbent material,
and wherein step (d) includes cooling the vapor chamber of a last one of the processing stages to cause condensation of the water vapor contained therein.

132. The atmospheric water generation method according to claim 129, wherein the heat transfer structure includes a heat exchanger plate provided with a plurality of protruding heat transfer elements extending from the heat exchanger plate into the vapor chamber of the preceding processing stage and/or into the vapor chamber of the following processing stage where the coated adsorbent layer is provided.

133. The atmospheric water generation method according to claim 132, wherein the protruding heat transfer elements include protruding fins, pins or heat pipes.

134. The atmospheric water generation method according to claim 111, wherein step (d) includes draining the condensate condensing in part or all of the vapor chambers.

135. The atmospheric water generation method according to claim 111, wherein the adsorbent material includes packed silica gel or zeolites.

136. The atmospheric water generation method according to claim 111, wherein step (c) includes heating the adsorbent structures to a temperature of approximately 80° C. to 90° C. or higher.

137. The atmospheric water generation method according to claim 111, wherein step (b) includes bringing the temperature of the adsorbent structures to a temperature that does not exceed 30° C.

138. The atmospheric water generation method according to claim 111, including operating first and second atmospheric water generation units side by side,
wherein the first atmospheric water generation unit is operated during a first cycle to cause desorption of water vapor at step (c), while the second atmospheric water generation unit is operated to cause adsorption of water at step (b),
and wherein operation of the first atmospheric water generation unit is switched during a second cycle to cause adsorption of water at step (b), while operation of the second atmospheric water generation unit is switched to cause desorption of water vapor at step (c).

139. The atmospheric water generation method according to claim 111, including coupling of the at least one atmospheric water generation unit to a thermal storage device.

140. The atmospheric water generation method according to claim 111, including coupling of the at least one atmospheric water generation unit to a thermal energy source originating from solar energy or industrial waste heat processes.

141. The atmospheric water generation method according to claim 140, including using heat generated by a solar energy harvesting system.

142. The atmospheric water generation method according to claim 141, wherein the solar energy harvesting system is a photovoltaic system.

143. The atmospheric water generation method according to claim 142, wherein the photovoltaic system is a concentrated photovoltaic system.

144. The atmospheric water generation method according to claim 111, further comprising the step of maintaining the at least one atmospheric water generation unit in a partial vacuum condition during desorption.

145. The atmospheric water generation method according to claim 144, wherein the partial vacuum condition is maintained by reducing overall system pressure in the adsorbent structures and vapor chambers using a vacuum pump connected to one or more collection tanks collecting the condensate.

146. The atmospheric water generation method according to claim 144, wherein pressure in the adsorbent structures and vapor chambers is lowered during desorption to a pressure of 5 kPa or less.
